(19) United States
(12) Patent Application Publication
(10) Pub. No.: US 2008/0203613 A1
(43) Pub. Date: Aug. 28, 2008

(54) Apparatus and Method For Making Product Having Various Shapes

(76) Inventor: Hyun Gwon Jo, Gyeonggi-do (KR)

Correspondence Address: ROBERTS MLOTKOWSKI SAFRAN & COLE, P.C., P. O. BOX 10064, MCLEAN, VA, 22102-8064, US

(21) Appl. No.: 11/722,346

(22) PCT Filed: Dec. 27, 2005
(86) PCT No.: PCT/KR05/04586

§ 371 Date: Jun. 20, 2007

(30) Foreign Application Priority Data
Dec. 27, 2004 (KR) 10-2004-0112985

(51) Int. Cl. B29C 70/00

(52) U.S. Cl. 264/239; 425/267

(57) ABSTRACT

The present invention relates to an apparatus and a method for making products having various shapes. The apparatus is for making a product by shaping or processing work piece using a relative movement between the work piece and a tool. The apparatus is provided with a work piece support on which the work piece is located, a revolution-rotation driving device including a first axis and a second axis in parallel with the first axis and revolving around the first axis, the device revolving the work piece support around the first axis and rotating the work piece support on the second axis; and a tool support for supporting the tool in such a manner that the tool is maintained in a predetermined position with respect to the first axis. The revolution-rotation driving device further includes a revolution-radius adjustment for adjusting so a distance between the first axis and the second axis. Further, the revolution-rotation driving device maintains a direction of the revolution of the work piece support and a direction of the rotation of the work piece support in a same direction and allows a ratio of the number of revolution of the work piece support to the number of rotation of the work piece support to be maintained in a constant ratio of n (natural number):1.

### TECHNICAL FIELD

The present invention generally relates to an apparatus and method for making products having various shapes.

### BACKGROUND ART

In general, articles such as pottery vessels have various shapes, e.g., an oval or a polygon such as a triangle, a quadrangle or a pentagon as well as a circle. Casting and press molding are known as conventional methods for shaping those pottery vessels. In the casting, a cavity is firstly formed by combining several molds into a particular shape fitting with a pottery vessel to be made and then clay is injected into the cavity. However, the casting cannot provide clay with a proper density enough for a good pottery vessel. In the press molding, a die and a punch are used. The die has a shape identical to that of a lower part (or an upper part) of the pottery vessel to be made, while the punch, which downwardly approaches, has a shape identical to the shape of an upper part (or the lower part) of the pottery vessel. Although the press molding may increase the density of clay, the pottery vessels manufactured by the press molding are inferior in quality to pottery vessels (having a circular shape) made by using a rotatable potter's wheel. Meanwhile, the rotatable potter's wheel by which pottery vessels having a circular shape can be manufactured have several advantages in that it increases the strength of the product vessels and reduces deformation of the product vessels, by allowing particles of clay to be moved and arranged by a pressing force exerted on clay in circumferential direction. However, it is difficult to make pottery vessels having various shapes other than the circular shape by using existing means for making pottery vessels, e.g., the potter's wheel, the potter's wheel for jiggering and automatic shaping devices.

### DISCLOSURE OF THE INVENTION

### Technical Problem

The object of the present invention is to provide an apparatus and a method for making products having a circular shape, an oval shape, shapes similar to polygonal shapes such as a triangular shape, a quadrangular shape and a pentagonal shape.

Another object of the present invention is to provide a potter's wheel for jiggering for making pottery vessels having a circular shape, an oval shape, and shapes similar to polygonal shapes such as a triangular shape, a quadrangular shape and a pentagonal shape.

Another object of the present invention is to provide an apparatus and a method for making products having a circular shape, an oval shape, shapes similar to polygonal shapes such as a triangular shape, a quadrangular shape and a pentagonal shape, wherein an eccentricity is adjustable.

Another object of the present invention is to provide an apparatus and a method for making products having a circular shape, an oval shape, shapes similar to polygonal shapes such as a triangular shape, a quadrangular shape and a pentagonal shape, wherein the products have various size.

### Technical Solution

According to one aspect of the present invention, an apparatus for making a product by shaping or processing work piece using a relative movement between the work piece and a tool comprising:
a work piece support on which the work piece is located;
a revolution-rotation driving device including a first axis and a second axis in parallel with the first axis and revolving around the first axis, the device revolving the work piece support around the first axis and rotating the work piece support on the second axis; and
a tool support for supporting the tool in such a manner that the tool is maintained in a predetermined position with respect to the first axis,
wherein the revolution-rotation driving device further includes a revolution-radius adjustment for adjusting a distance between the first axis and the second axis,
and wherein the revolution-rotation driving device maintains a direction of the revolution of the work piece support and a direction of the rotation of the work piece support in a same direction and allows a ratio of the number of revolution of the work piece support to the number of rotation of the work piece support to be maintained in a constant ratio of n (natural number):1, is provided.

In the apparatus, the revolution-rotation driving device may further include a sun-shaft extending along the first axis and a planet-shaft to which the work piece support is fixed, the planet-shaft extending along the second axis.

In the apparatus, the revolution-rotation driving device may further include a first driving motor rotating the sun-shaft on the first axis and a second driving motor for rotating the planet-shaft on the second axis.

In the apparatus, the revolution-radius adjustment of the revolution-rotation driving device may include a revolution frame rotating on the first axis, a transfer screw mounted to the revolution frame and extending in a direction perpendicular to the first axis, and a transfer module to which the planet-shaft is attached, the transfer module movable in a radial direction of the first axis along the transfer screw.

In the apparatus, the revolution-rotation driving device may further include a rotational plate rotating on the first axis, an internal gear being rotatable on the second axis and rotatably supported by the rotational plate, the internal gear connected to the work piece support, and an external gear cooperating with the internal gear, wherein the external gear is linked to a fixed shaft at its portion separated from a center of the external gear, a distance between the first axis and the center of the external gear is identical to a distance between the fixed shaft and the portion of the external gear, and a distance between the first axis and the fixed shaft is identical to a distance between the center of the external gear and the portion of the external gear.

In the apparatus, the revolution-rotation driving device may further include a sun-gear existing on the first axis and being stationary, a rotational plate to which the planet-shaft is rotatably mounted, the rotational plate attached to the sun-shaft to be rotatable on the first axis, a planet-gear fixed to the planet-shaft, and a connection gear connecting the sun-gear to the planet-gear.

In the apparatus, the connection gear may include a first intermediate gear cooperating with the sun-gear, a second intermediate gear cooperating with the planet-gear, and an intermediate shaft connecting the first intermediate gear to the second intermediate gear.

In the apparatus, the revolution-radius adjustment may be configured in such a manner that, when a position of the intermediate shaft is stationary with respect to the rotational plate, the planet-gear is engaged with the first intermediate gear and to be moved around the intermediate shaft.

In the apparatus, the revolution-rotation driving device may further include a rotational plate to which the planet-shaft is rotatably mounted, the rotational plate being rotatable on the first axis, and a power-transmitting device transmitting a rotational force from the sun-shaft to the planet-shaft.

In the apparatus, the power-transmitting device may be of a constant joint or a universal joint.

In the apparatus, the universal joint may be adapted to adjust relative angular position of both joints to each other.

In the apparatus, the power transmitting device may include an input gear rotatable with the sun-shaft, an output gear rotatable with the planet-gear, an intermediate gear cooperating with the input gear and the output gear, a first link rotatably connecting a shaft of the intermediate gear and the planet-shaft, and a second link rotatably connecting the shaft of the intermediate gear and the sun-shaft.

In the apparatus, the revolution-rotation driving device may further include a chain or a timing belt for revolving the work piece support around the first axis and a chain or a timing belt for rotating the work piece support on the second axis.

In the apparatus, the revolution-rotation driving device may further include a controller for changing the ratio of the number of revolution of the work piece support to the number of rotation of the work piece support.

According to another aspect of the present invention, a method of making a product, comprising the steps of:
locating a work piece to be shaped or processed on a work piece support;
revolving the work piece support around a first axis, rotating the work piece support on a second axis at the same time, maintaining a direction of the revolution of the work piece support and a direction of the rotation of the work piece support in a same direction, and allowing a ratio of the number of revolution of the work piece support to the number of rotation of the work piece support to be maintained in a constant ratio of n (natural number):1; and
positioning a tool in a position separated from the first axis by a predetermined distance, is provided.

The method may further comprise a step of adjusting a distance between the first axis and the second axis.

The method may further comprise a step of adjusting a distance between the first axis and the tool.

According to another aspect of the present invention, a product made by a method of making a product, the method comprising the steps of:
locating a work piece to be shaped or processed on a work piece support;
revolving the work piece support around a first axis, rotating the work piece support on a second axis at the same time, maintaining a direction of the revolution of the work piece support and a direction of the rotation of the work piece support in a same direction, and allowing a ratio of the number of revolution of the work piece support to the number of rotation of the work piece support to be maintained in a constant ratio of n (natural number):1; and
positioning a tool in a position separated from the first axis by a predetermined distance.

The product may have a polygonal shape.

### Advantageous Effects

With the configuration of the present invention, all of the objects described above can be achieved. More specific, since a mold support is provided on a planet-shaft revolving around a sun-shaft and rotating on its own axis, products having an oval shape or a polygonal shape such as a triangular shape and a quadrangular shape can be easily obtained. Further, since the planet-shaft can be changed in position in a radial direction of the sun-shaft, products having a circular shape can be made and it is possible to diversify products having polygonal shapes in shape.

### DESCRIPTION OF DRAWINGS

The above and other objects and features of the present invention will become apparent from the following description of the embodiments provided in conjunction with the accompanying drawings.

FIG. 1 shows a scheme of a potter's wheel for jiggering in accordance with a first embodiment of the inventive apparatus for making products;

FIG. 2 shows a perspective view of the revolution-rotation driving device shown in FIG. 1;

FIGS. 3a through 3f show a process of shaping a quadrangular vessel by the potter's wheel for jiggering shown in FIG. 1;

FIG. 4 shows a top planar view of the quadrangular vessel made through the process shown in FIGS. 3a through 3f.

FIGS. 5 and 6 show two cases where the quadrangular vessels are shaped by the potter's wheel for jiggering shown in FIG. 1, respectively;

FIGS. 7a through 7d show a process of shaping a triangular vessel by the potter's wheel for jiggering shown in FIG. 1;

FIGS. 8a and 8b show a process of shaping an octagonal vessel by the potter's wheel for jiggering shown in FIG. 1;

FIG. 9 shows a scheme of a potter's wheel for jiggering in accordance with a second embodiment of the inventive apparatus for making products;

FIG. 10 shows a principal of making an oval vessel using the potter's wheel for jiggering shown in FIG. 9.

FIGS. 11a through 11d show steps of a process of shaping an oval vessel by the potter's wheel for jiggering shown in FIG. 9;

FIGS. 12a and 12b show an example where a quadrangular vessel is shaped by the potter's wheel for jiggering shown in FIG. 9;

FIG. 13 shows a scheme of a revolution-rotation driving device of a potter's wheel for jiggering in accordance with a third embodiment of the inventive apparatus for making products;

FIG. 14 shows a scheme of a revolution-rotation driving device of a potter's wheel for jiggering in accordance with a fourth embodiment of the inventive apparatus for making products;

FIG. 15 shows a scheme of a revolution-rotation driving device of a potter's wheel for jiggering in accordance with a fifth embodiment of the inventive apparatus for making products; and

FIG. 16 shows a scheme of a universal joint used as a substitute for a constant joint shown in FIG. 14.

### BEST MODE

Herein below, a preferred embodiment of the present invention will be described with reference to the accompanying drawings.

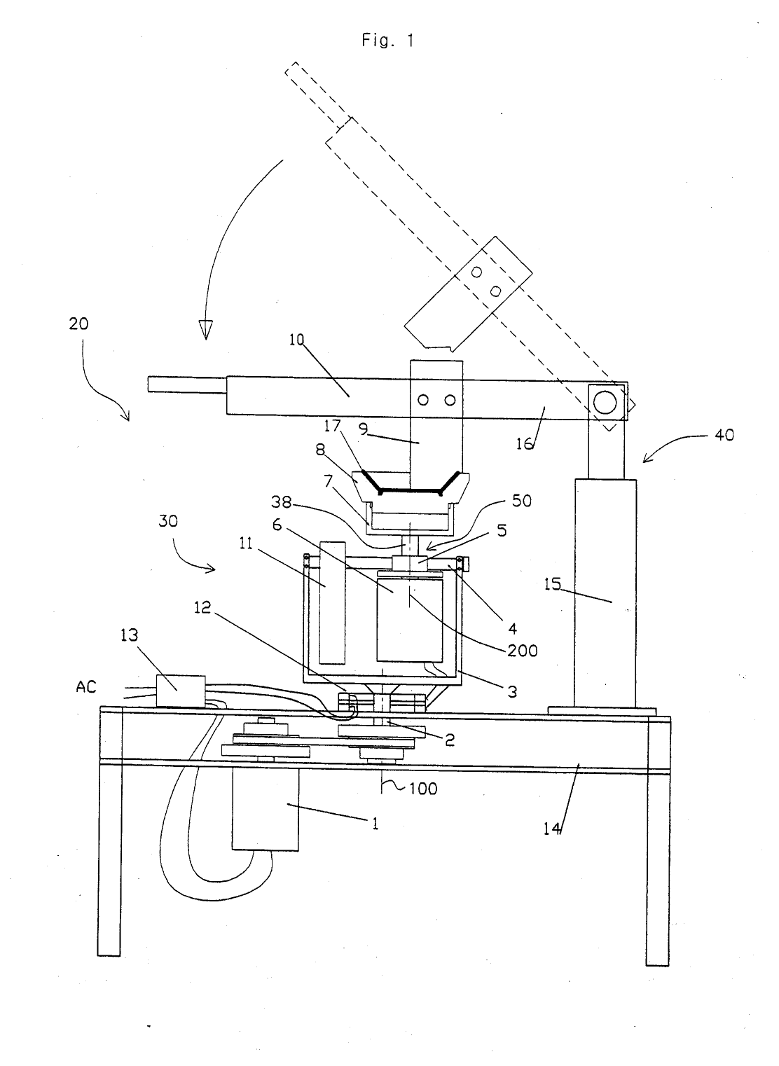

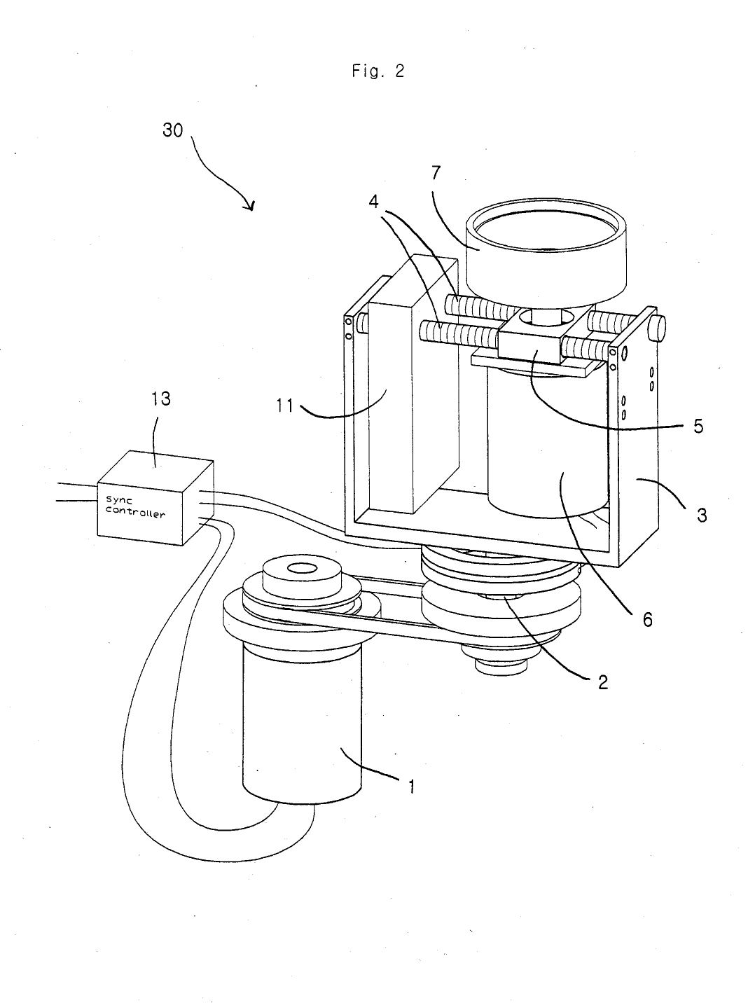

FIGS. 1 through 8 show a first embodiment of the present invention. Referring to FIGS. 1 and 2, a potter's wheel for jiggering 20 includes a support frame 14, a revolution-rotation driving device 30 and a tool support 40. The revolution-rotation driving device 30 and the tool support 40 are mounted on the support frame 14. The revolution-rotation driving device 30 includes a first driving motor 1, a sun-shaft 2, a revolution-frame 3, a revolution-radius adjustment 50, a second driving motor 6, a planet-shaft 38, a controller 13 and a power bridge 12. A pulley is used to transmit the driving force of the first driving motor 1 to the sun-shaft 2. However, the present invention is not limited to the pulley and other power transmissions such as a gear may be used. Further, a shaft of the first driving motor 1 may be directly connected to the sun-shaft 2. The rotational speed of the first driving motor 1 may be increased or decreased as necessary. The sun-shaft 2 extends upwardly and downwardly along a first axis 100. The center of rotation of the sun-shaft 2 is the first axis 100. The revolution-frame 3 is fixed to an upper portion of the sun-shaft 2 and is revolved by the rotational force of the sun-shaft 2. The revolution-radius adjustment 50 includes a pair of transfer screws 4 horizontally extending parallel with each other and a transfer module 5 moving in radial direction of the sun-shaft 2 along the pair of transfer screws 4. A counter weight 11 is provided in one end of the pair of transfer screws 4. The second driving motor 6 is combined to a lower portion of the transfer module 5. A shaft of the second driving motor 6 is connected to the planet-shaft 38 extending upwardly along a second axis 200. A mold support 7 is fixed to an upper end of the planet-shaft 38. The mold support 7 has a mold 8 for clay 17 fixed thereon. The rotational shaft 61 of the second driving motor 6 plays a role of the planet-shaft. The controller 13 controls rotations of the first driving motor 1 and the second driving motor 6. The controller 13 functions as a revolution/rotation controller, which controls a ratio of the number of revolution to the number of rotation of the planet-shaft 61. A lower end of the tool support is combined to the support frame 14 and includes a column 15 extending upwardly, a tool handle 16 rotatably attached to an upper end of the column 15, where an end of the tool handle 16 is movable up and down, and a template (a shaping blade) 9 attached to the tool handle 16. When the tool handle 16 rotates with respect to the column 15, the template 9 comes into a contact with the clay 17 or is removed from the clay 17.

Now, a detailed description of the first embodiment will be given with reference to FIGS. 2 through 8.

The second axis 200 is separated from the first axis 100 by a certain distance in the radial direction of the first axis 100. The distance can be adjusted when the transfer module 5 linearly moves along the transfer screws 4. The linear motion is to adjust the eccentricity of shapes to be made. When the first driving motor 1 rotates the sun-shaft 2, the revolution-frame 3 attached to the sun-shaft 2 is revolved around the first axis 100. The transfer screws 4 fixed to the revolution-frame 3 is also revolved around the first axis 100. As a result, the planet-shaft 61 revolves around the sun-shaft 2. The revolution-radius of the planet-shaft 61 varies according to the position of the transfer module 5. Further, the second driving motor 6 rotate the planet-shaft 61. When the ratio of the number of rotation of the planet-shaft 61 to the number of rotation of the sun-shaft 2 (the ratio of RPM (rotation per minutes) of the planet-shaft to that of the sun-shaft), is changed, the vessel to be manufactured has different shapes. The relationship between the ratio and resulted shapes are shown in the following table.

TABLE 1

| | | Absolute rotation of | |
|---|---|---|---|
| | Rotation of | planet-shaft resulted | |
| Rotation of | planet-shaft on | from revolution and | Shape of vessel |
| sun-shaft | its own axis | rotation | to be made |
| 1 | 0 | 1 | A circular shape |
| 2 | −1 | 1 | An oval shape |
| 3 | −2 | 1 | A shape similar |
| | | | to a triangular |
| | | | shape |
| 4 | −3 | 1 | A shape similar |
| | | | to a quadrangular |
| | | | shape |
| 5 | −4 | 1 | A shape similar |
| | | | to a pentagonal |
| | | | shape |
| . . . | . . . | 1 | . . . |
| n | 1-n | 1 | A shape similar |
| | | | to a polygonal |
| | | | shape having |
| | | | n sides |

When the planet-shaft and the sun-shaft exist in a same straight line, a vessel having a circular shape is resulted.

Although the motors are used in this embodiment for the adjustment of the rotation ratio of the planet-shaft to the sun-shaft, power transmissions guaranteeing an exact rotation ratio such as gear sets or timing pulleys may be employed. In case that motors are used, the rotational speed of the motors can be controlled by a controller or an inverter. In case that gear sets or timing pulleys are used, the rotation ratio between the planet-shaft and the sun-shaft can be changed by replacing the gear sets or timing pulleys with other gear sets or timing pulleys. Especially, in case of the gear set, internal gears or external gears may be used for the same purpose, which will be described in detail later.

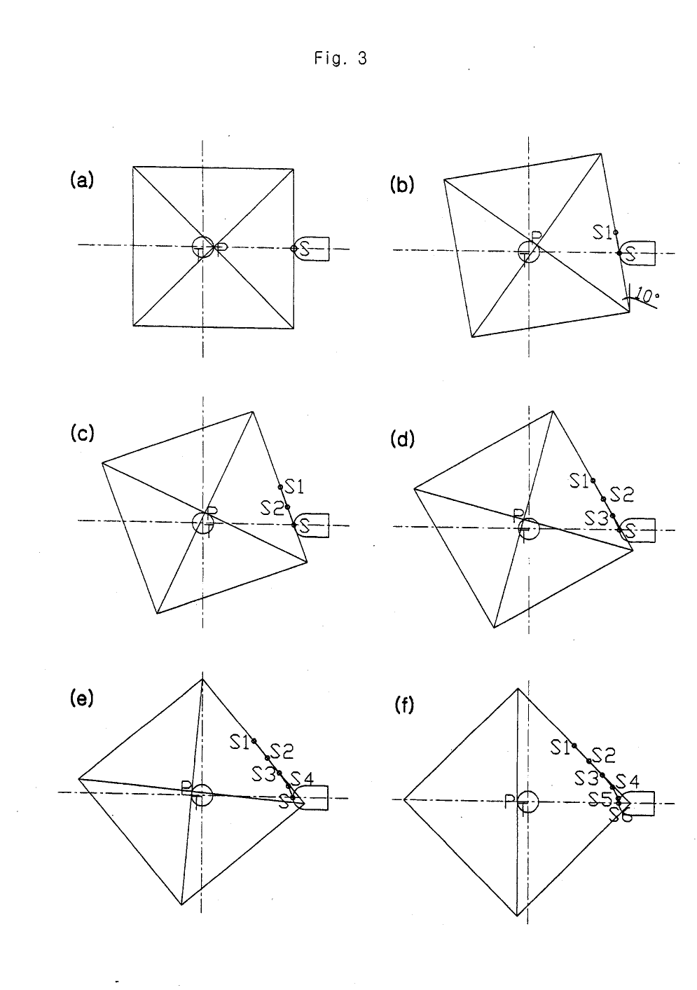

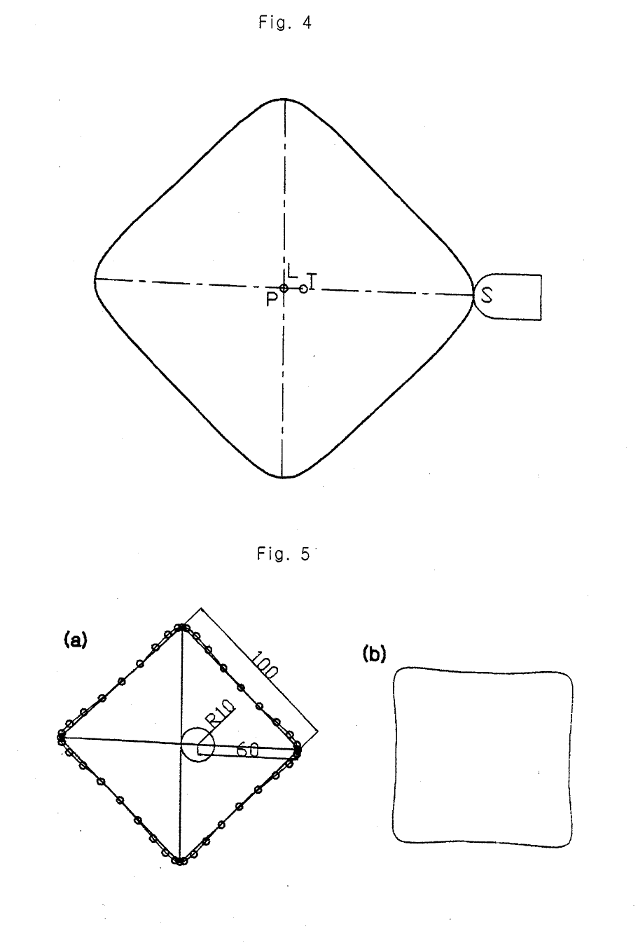

FIGS. 3a through 3f show a process of making a vessel with a quadrangular shape by using the potter's wheel for jiggering described above. In FIG. 3, T means the position of the sun-shaft (reference numeral 2 in FIG. 1), while P (reference numeral 61 in FIG. 1) means the position of the planet-shaft. During the process of FIGS. 3a through 3f, the planet-shaft revolves around the sun-shaft by 180 degree, while rotating on its own axis 45 degree, and portions of the work piece passing by one point on the template establish a path S. When the planet-shaft revolves around the sun-shaft four times, while rotating on its own axis one time, a quadrangular vessel is manufactured as shown in FIG. 4. The principal of shaping the vessel like these is similarly applied to shaping other polygonal vessels such as a triangular vessel.

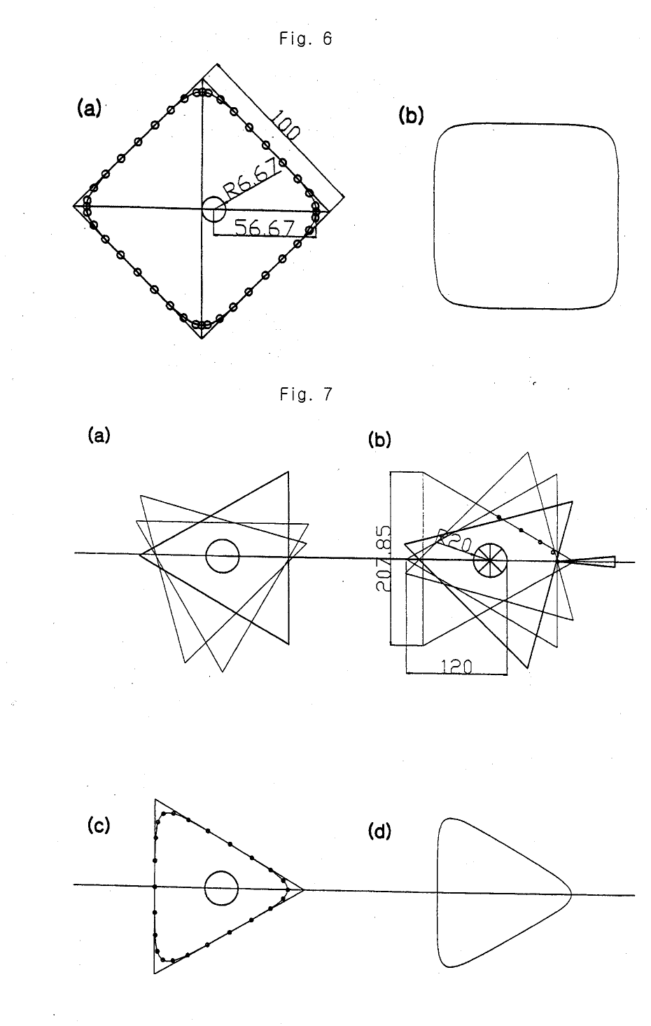

Further, the vessels having a quadrangular shape have differently shaped sides according to the eccentricity. This will be shown in FIGS. 5 and 6. The term, the eccentricity, is defined in the present invention as a ratio of the revolution-radius (distance between the sun-shaft and planet-shaft) to magnitude of the vessel to be manufactured (distance between the sun-shaft and the template). The eccentricity has something to do with the pointedness of the corner of the vessel to be made. The larger the eccentricity is, the more pointed the corners of the vessel having a polygonal shape becomes. In case of an oval, as the eccentricity is larger, the oval becomes more elongated. It is seen from the comparison between FIGS. 5 and 6 that each side of the vessel manufactured under a larger eccentricity (when the revolution-radius is relatively larger than the magnitude of the vessel; FIG. 5) becomes more concave than the side of the vessel manufactured under a smaller eccentricity (when the revolution-radius is relatively smaller; FIG. 6). The adjustment of the eccentricity of the vessel to be made is achieved by moving the transfer module 5 by using the transfer screws 4.

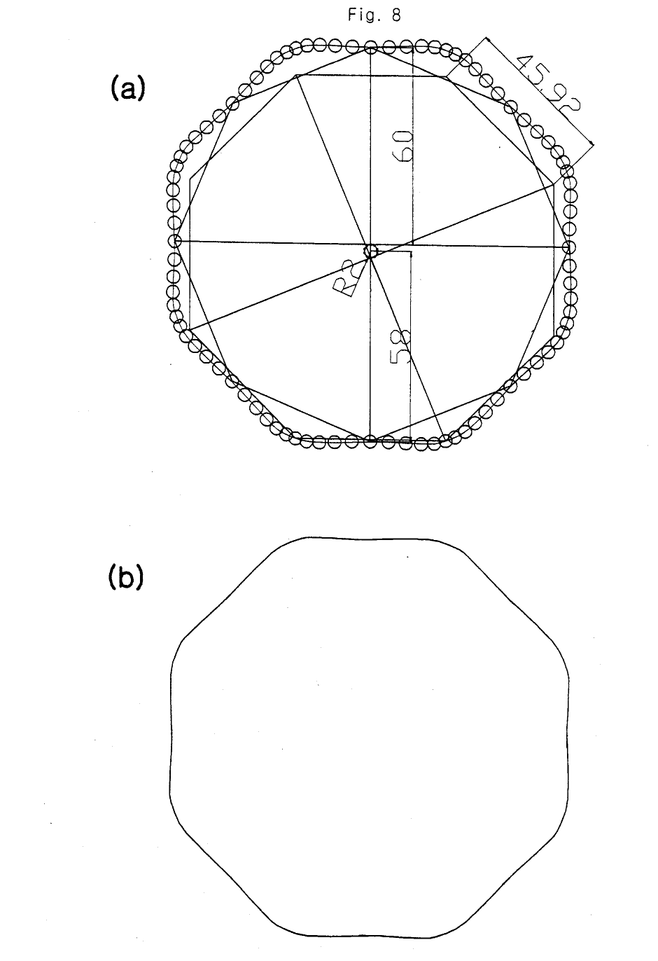

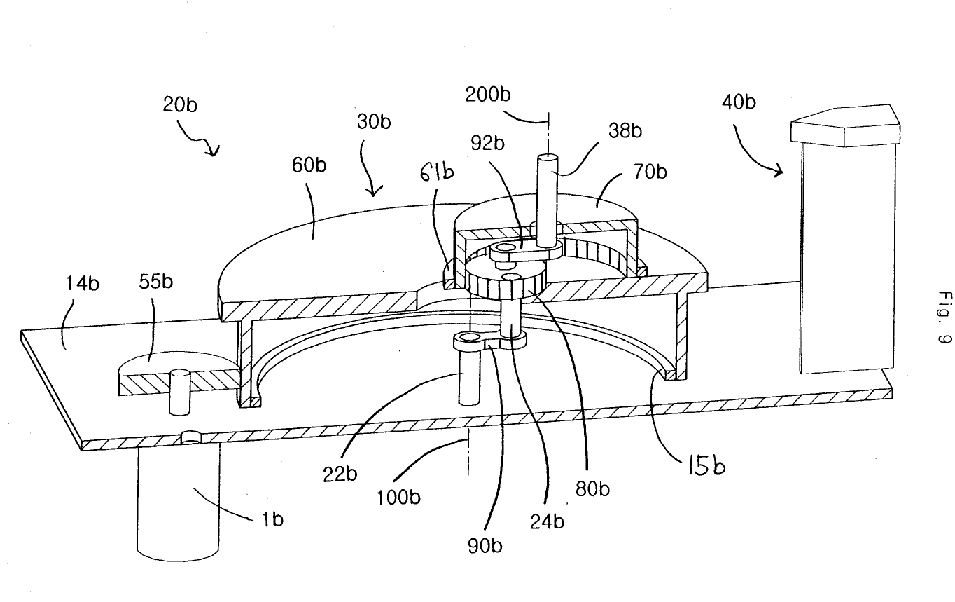

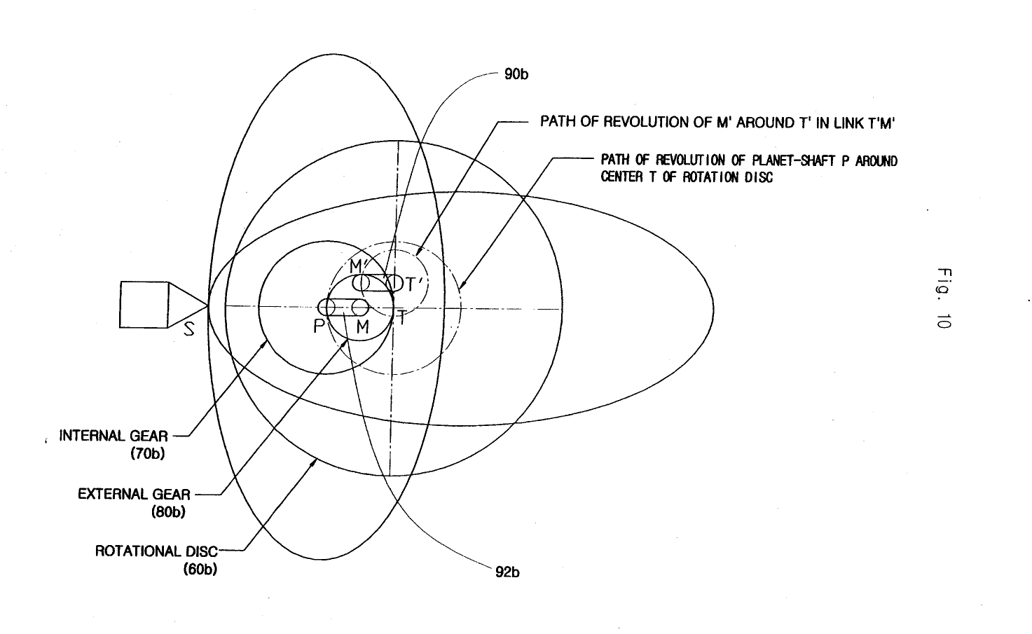

In FIGS. 7a through 7d, shaping process of a triangular vessel is shown. In FIGS. 8a and 8b, there is shown a process of shaping an octagonal vessel.

FIGS. 9 through 12 show the second embodiment of the present invention. Referring to FIG. 9, a potter's wheel for jiggering 20b includes a support frame 14b, a revolution-rotation driving device 30b and a tool support 40b. A shaft 22b is mounted to the support frame 14b. In FIGS. 10 through 12, the position of the shaft 22b is indicated with T′. The revolution-rotation driving device 30b includes a driving motor 1b, a rotational disc 60b, an internal gear 70b, an external gear 80b, a first link 92b and a second link 90b. The driving motor 1b is provided with a friction wheel 55b for rotating the rotational disc 60b. The rotational disc 60b is supported by the support frame 14b through a bearing set 15b and is rotated by the driving motor 1b. At the moment, the center of rotation of the rotational disc 60b is a first axis 100b. In FIGS. 10 through 12, the position of the first axis 100b is indicated with T. The internal gear 70b is mounted to the rotational disc 60b through a bearing set 61b and has a second axis 200b as its center of rotation. A planet-shaft 38b extends along the second axis 200b, which rotates with the internal gear 70b. In FIGS. 10 through 12, the planet-shaft 38b is indicated with P. Although not described in detail, the internal gear 70b is able to move in a radial direction of the first axis 100b to change a revolution-radius of the second axis 200b. The external gear 80b is inscribed on an inside of the internal gear 70b. In drawings, a center of the external gear 80b is indicated with M. An intermediate shaft 24b is provided in the external gear 80b on a position separated from the center of the external gear 80b. The intermediate shaft 24b extends toward the support frame 14b. In drawings, the position of the intermediate shaft 24b is indicated with M′. The planet-shaft 38b and the center of the external gear 80b are rotatably connected by the first link 92b. The shaft 22b and the intermediate shaft 24b are rotatably connected by the second link 90b.

Now, a detailed description of the second embodiment will be given with reference to FIGS. 9 and 10. The rotation of the driving motor 1b and then the rotation of the friction wheel 55b result in rotation of the rotational disc 60b through which the first axis 100b passes. The rotational disc 60b rotates at a fixed position of the center T, while the internal gear 70b connected to the rotational disc 60b through the bearing set revolves around T. The internal gear 70b is rotated by an interference of the external gear 80b inscribed thereon. The number of rotation of the internal gear 70b depends on a gear ratio of the external gear 80b to the internal gear 70b. According to the change of the gear ratio, various desired polygons can be shaped under the same principal as that in the first embodiment. The external gear 80b is maintained in a constant direction by interference between T′ existing on the shaft 22b and the second link 90b rotatable about T′. TT′MM′ establish an imaginary parallelogram link. For this, the distance between T and T′ and the distance between M and M′ are maintained equal to each other and the distance between T and M and the distance between T′ and M′ are also maintained equal to each other. The internal gear 70b rotates on P through which the second axis 200b goes, while revolving around T, which is a center of the rotational disc 60b. At the moment, since the external gear 80b revolves around T only without the rotation on its own axis, it performs a function similar to a sun gear with respect to the internal gear 70b.

The distance between the centers of the external gear 80b and the internal gear are maintained constant by the link, etc., and may be changed by an adjustment of a length of the link. The internal gear 70b is rotatable with respect to the rotational disc 60b since it is maintained on the rotational disc 60b through the bearing set. The rotational disc 60b is rotatable since it is maintained on the support frame 14b through the bearing set 15b and it is rotated by the driving motor 1b. A predetermined ratio of the number of revolution to the number of rotation can be applied to the external gear 80b and the internal gear 70b and circles, ovals or equilateral polygons which have P as its center can be shaped by S of the fixed template previously described. P also corresponds to a center of the external gear and the planet-shaft. When a gear ratio of the external gear to the internal gear is 1:2, an oval is made. When the gear ratio is 2:3 and 3:4, a triangle and a quadrangle are made, respectively. When the gear ratio is n−1:n, a polygon having n number of sides is made.

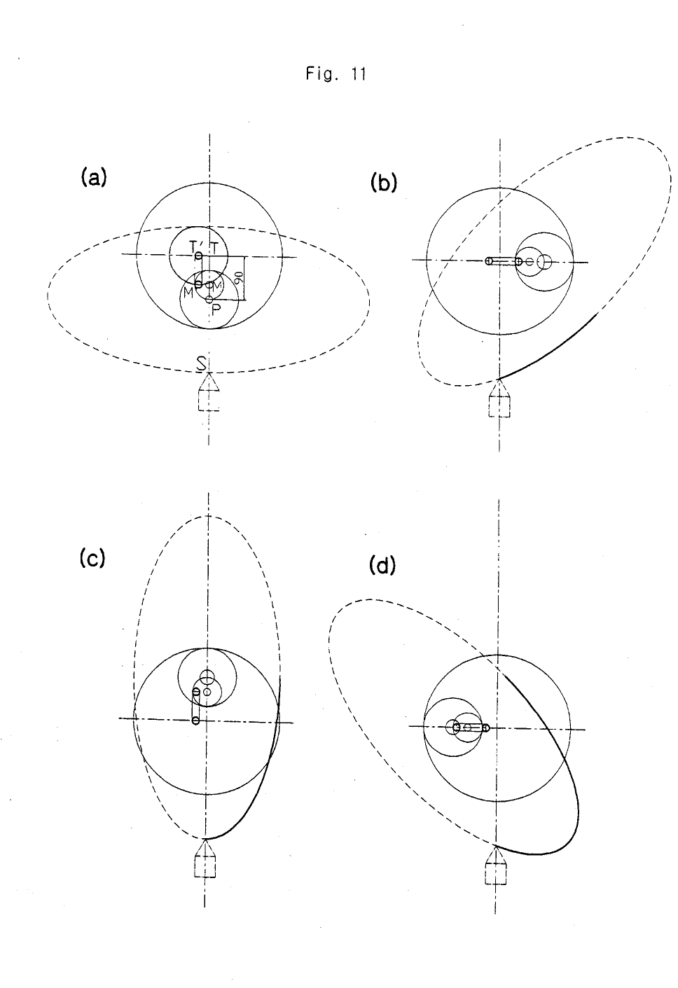

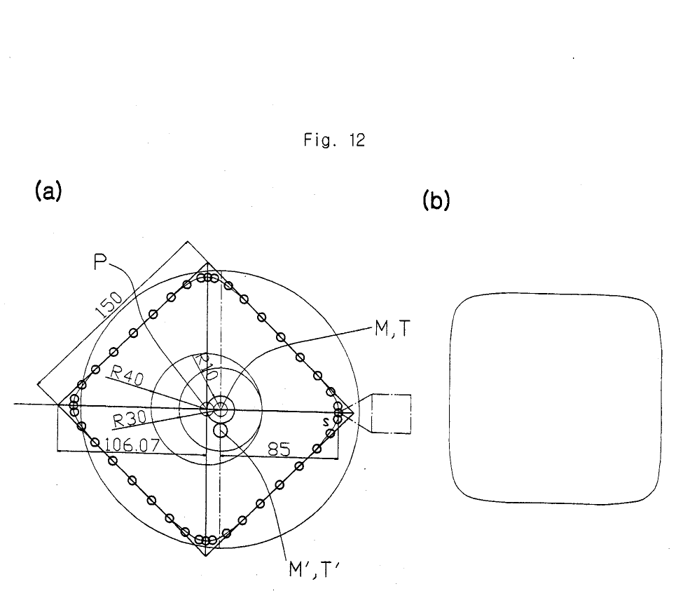

FIGS. 11a through 11d show steps of a process of shaping a vessel having an oval shape, respectively. FIGS. 12a and 12b show a process of shaping a vessel having a quadrangular shape, wherein the center of the external gear is stationary on the center of its revolution.

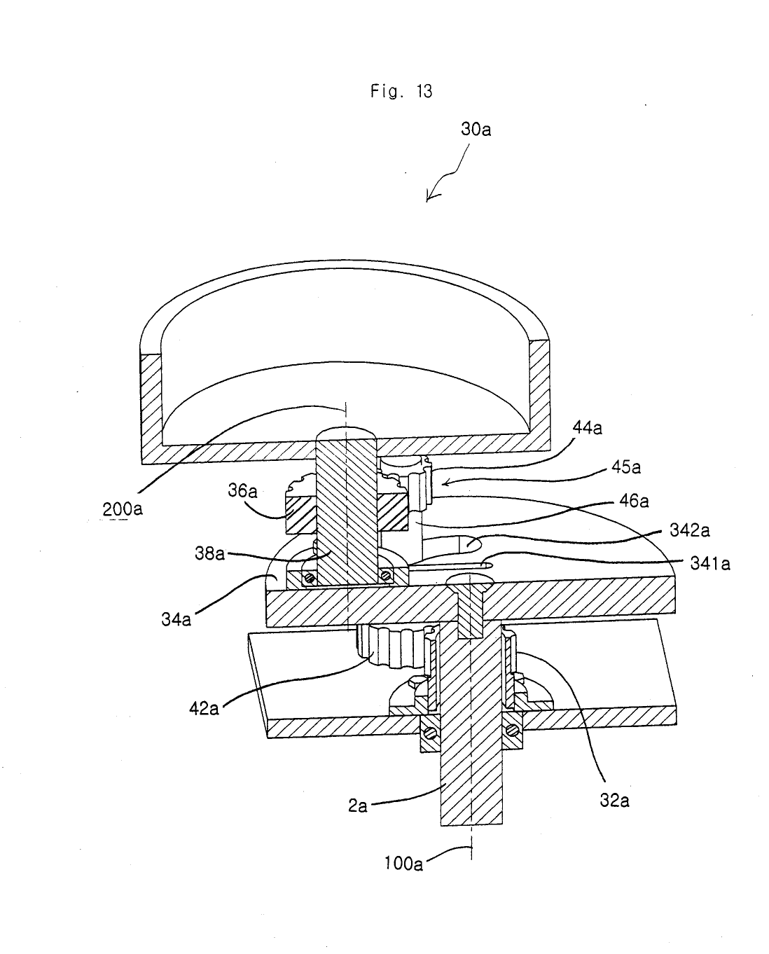

FIG. 13 shows a revolution-rotation driving device of a potter's wheel for jiggering in accordance with a third embodiment of the present invention. Referring to FIG. 13, the revolution-rotation driving device 30a includes a stationary sun gear 32a, a sun-shaft 2a being rotatable and passing through a center of the sun gear 32a, a rotational plate 34a attached to the sun-shaft 2a and being rotatable by the rotation of the sun-shaft 2a, a planet-shaft 38a rotatably connected to the rotational plate 34a and being movable in a radial direction of the sun-shaft 2a and having a planet gear 36 fixed thereto, and a connection gear 45a. The connection gear 45a includes a first intermediate gear 42a, a second intermediate gear 44a and an intermediate shaft 46a connecting the first intermediate gear 42a to the second intermediate gear 44a. A first axis 100 exists in an extension of the sun-shaft 2a, while the extension of the planet-shaft 38a establishes the second axis 200a. A guide slit 341a guiding a radial movement of the planet-shaft 38a and a shaft hole 342a through which the intermediate shaft 46a passes, are formed through the rotational plate 34a. The shaft hole 342a is formed along a circumferential direction to allow the intermediate shaft 46a to be moved along the circumferential direction. Provided at both ends of the intermediate shaft 46a are the first intermediate gear 42a connected to the sun-shaft 32a and the second intermediate gear 44a connected to the planet gear 36a.

Referring to FIG. 13, the sun gear 32a is stationary. The planet-shaft 38a having the planet gear 36a attached thereto is movable toward or away from the sun-shaft 2a in a straight line. The distance corresponds to the revolution-radius of the planet-shaft. The intermediate shaft 46a and the intermediate gears 42a, 44a function to allow the ratio of the number of revolution of the planet-shaft to the number of rotation of the planet-shaft (hereinafter “the revolution-rotation ratio”) to be constantly maintained regardless of the distance between the sun-shaft 2a and the planet-shaft 38a. In case that the numbers of teeth of the first intermediate gear 42a and the sun gear 32a are identical, it is possible to obtain a desired revolution-rotation ratio by replacing the second intermediate gear 44a and the planet gear 38a with other ones having a proper gear ratio therebetween. On the contrary, in case that the numbers of teeth of the second intermediate gear 44a and the planet gear 38a are identical, it is possible to obtain a desired revolution-rotation ratio by replacing the first intermediate gear 42a and the sun gear 32a with other ones having a proper gear ratio therebetween. Therefore, various vessels having a different shape can be shaped under the same principal as that in the first embodiment. It is described in the third embodiment that when the planet-shaft 38a, which is changeable in position, is stationary in one place, the intermediate shaft 46a moves toward the planet-shaft 38a to make engagements between the gears. However, it can be seen by those skilled in the art that it is possible that the planet-shaft 38a is moved toward the intermediate shaft 46a fixed with respect to the rotational plate 34a for making the engagements between the gears.

Although it is described in the third embodiment that the intermediate shaft, the sun-shaft and the planet-shaft are connected to one another through the gears, the present invention is not limited to this. It can be seen by those skilled in the art that connection through a chain or a timing belt can be employed.

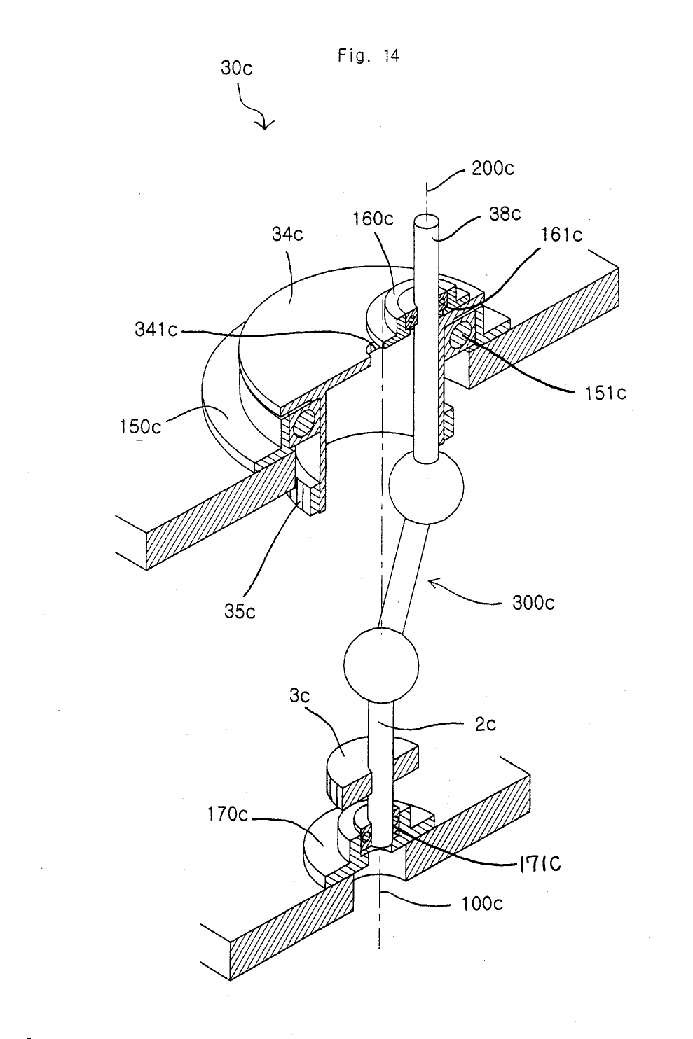

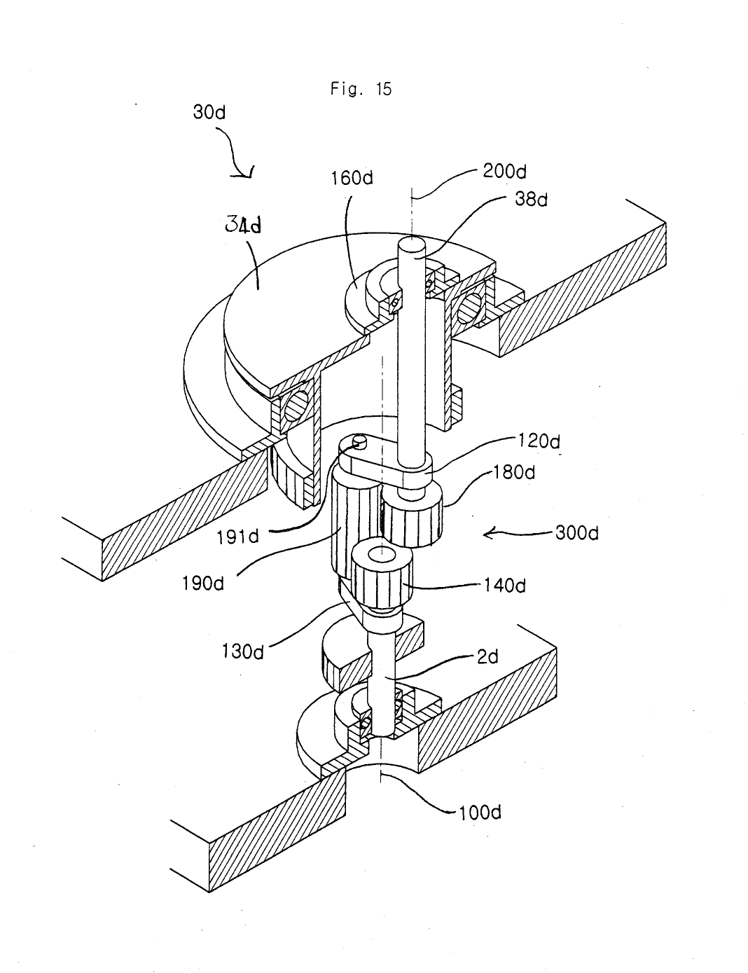

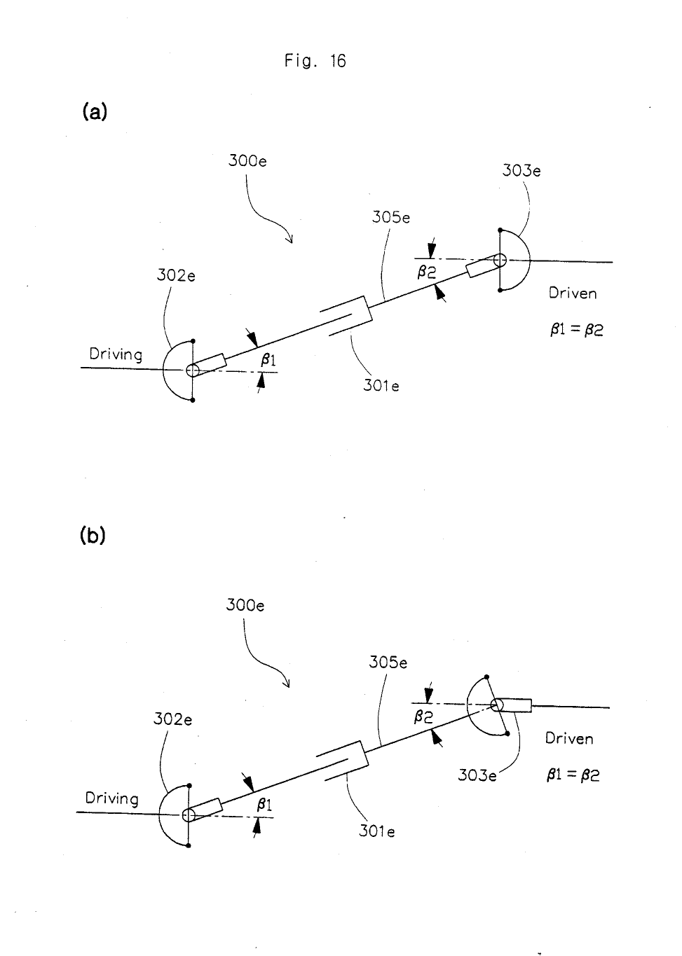

FIG. 14 shows a revolution-rotation driving device of a potter's wheel for jiggering in accordance with the fourth embodiment of the present invention. Referring to FIG. 14, the revolution-rotation driving device 30c includes a rotational plate support 150c, a rotational plate 34c, a planet-shaft support 160c, a planet-shaft 38c, a constant joint 300c, a sun-shaft 2c and a sun-shaft support 170c. The rotational plate 34c is rotatably supported by the rotational plate support 150c through a bearing set 151c, wherein the rotational plate 34c is rotatable on a first axis 100c extending upwardly and downwardly and the rotational plate support 150c is immovably fixed. A guide hole 341c for guiding the movement of the planet-shaft support 160c is provided in the rotational plate 34c. The rotational plate 34c is provided with a first gear 35c for transmission of a power to the rotational plate 34c. Alternatively, the rotation of the rotational plate 34c may be achieved by using other power transmission such as a timing belt. The first driving motor (not shown) rotates the rotational plate 34c and the rotation of the rotational plate 34c allows the planet-shaft 38c to be revolved around the first axis 100c. The planet-shaft 38c extends along a second axis 200c in parallel with the first axis 100c and is rotatably supported by the planet-shaft support 160c through a bearing set 161c, wherein the planet-shaft 38c rotates on the second axis 200c. The planet-shaft support 160c is movable in a radial direction of the first axis 100c along the guide hole 341c provided in the rotational plate 34c and is anchored to a proper position of the rotational plate 34c. The upper end of the planet-shaft 38c is connected to a mold support (not shown), while the lower end is connected to the constant joint 300c. The sun-shaft 2c extends along the first axis 100c and is rotatably supported by the sun-shaft support 170c through a bearing set 171c, wherein the sun-shaft 2c rotates on the first axis 100c. The sun-shaft 2c has a second gear 3c transmitting a power to the sun-shaft 2c for rotation of the sun-shaft 2c. Alternatively, the rotation of the sun-shaft 2c may be obtained by using other power transmission such as a timing belt or etc. The second driving motor (not shown) rotates the sun-shaft 2c and the rotation of the sun-shaft 2c allows the planet-shaft 38c to be rotated on the second axis 200c. The upper end of the sun-shaft 2c is connected to the constant joint 300c. The sun-shaft support 170c is immovably fixed. Both ends of the constant joint 300c are connected to the sun-shaft 2c and the planet-shaft 38c, respectively, and, therefore, the rotation of the sun-shaft 2c is directly transmitted to the planet-shaft 38c.

When the rotational plate 34c and the sun-shaft 2c are rotated, after the planet-shaft support 160c is changed in position in order to allow the second axis 200c to be separated from the first axis by a predetermined distance, the planet-shaft 38c is revolved around the first axis 100c and is rotated on the second axis 200c at the same time due to the rotational force directly transmitted from the sun-shaft 2c through the constant joint 300c. Since the revolution of the planet-shaft 38c is achieved independently of its rotation, the revolution-rotation ratio of the planet-shaft 38c can be freely adjusted. Therefore, vessels having various shapes can be shaped under the same principal as that in the first embodiment.

Although it is described in the fourth embodiment that different motors rotate the rotational plate 34c and the sun-shaft 2c, respectively, the present invention is not limited to this. For example, it is possible that one motor and a speed change gear having an integer proportion and connected to the motor are used and the rotational forces are transmitted to the rotational plate and the sun-shaft, respectively, through gears or timing belts.

Although it is described in the fourth embodiment that the rotational force from the sun-shaft 2c is transmitted to the planet-shaft 38c through the constant joint 300c, the present invention is not limited to this. A universal joint 300e shown in FIG. 16 may be used as a substitute for the constant joint. A spline 301 is provided in a middle shaft 305e to adjust relative angular positions of both yokes 302e, 303e to each other In case that the universal joint 300e is used as shown in FIG. 16a, wherein both yokes 302e, 303e are parallel and offset angles at both joints are identical, the universal joint performs the same function as that of the constant joint. If the universal joint 300e is used as shown in FIG. 16b, where both yokes 302e, 303e are not parallel and becomes inclined to each other at any angular magnitude (90 degree in FIG. 16b) from adjustment of the spline 301e, variation of trigonometric function of two cycles per rotation of the joint occurs due to a Cardan error. In other words, the angular velocity of the rotation of the planet-shaft varies in trigonometric function of two cycles per rotation of the sun-shaft. For this, variation occurs between speed of the revolution and speed of the rotation corresponding to the revolution and products having a shape other than a complete polygon or a shape similar to the polygon can be made by using the variation. For example, a shape similar to a rectangular shape can be made at four of the revolution/rotation ratio.

FIG. 15 shows a revolution-rotation driving device 30d of a potter's wheel for jiggering in accordance with the fifth embodiment of the present invention. Referring to FIG. 15, the rotational force from a sun-shaft 2d is transmitted to a planet-shaft 38d through a power transmitting device 300d provided with a first link and a second link 120d, 130d, an input gear 140d, an output gear 180d and an intermediate gear 190d. The input gear 140d is fixed to the sun-shaft 2d and is rotated therewith. The input gear 140d is engaged with the intermediate gear 190d to cooperate therewith. The output gear 180d is fixed to the planet-shaft 38d and is rotated therewith. The output gear 180d is engaged with the intermediate gear 190d to cooperate therewith. The intermediate gear 190d is engaged with the input gear 140d and the output gear 180d to transmit the rotational force from the input gear 140d to the output gear 180d. The planet-shaft 38d is rotatably connected to an intermediate gear shaft 191d through the first link 120d. The sun-shaft 2d is rotatably connected to the intermediate gear shaft 191d through the second link 130d. Since other configurations are the same as those in FIG. 14, detailed description about that will be omitted.

When a rotational plate 34d and the sun-shaft 2d are rotated, after a planet-shaft support 160d is changed in position in order to allow a second axis 200d to be separated from a first axis 100d by a predetermined distance, the planet-shaft 38d is revolved around the first axis 100d and is rotated on the second axis 200d at the same time due to the rotational force directly transmitted from the sun-shaft 2d through the power transmitting device 300d. Since the revolution of the planet-shaft 38d is achieved independently of its rotation, the revolution-rotation ratio of the planet-shaft 38d can be freely adjusted. Therefore, vessels having various shapes can be shaped under the same principal as that in the first embodiment.

While the present invention has been shown and described herein with respect to the particular embodiments, those skilled in the art will recognize that many exchanges and modifications may be made without departing from the scope of the invention as defined in the appended claims.

1. An apparatus for making a product by shaping or processing work piece using a relative movement between the work piece and a tool comprising:
a work piece support on which the work piece is located;
a revolution-rotation driving device including a first axis and a second axis in parallel with the first axis and revolving around the first axis, the device revolving the work piece support around the first axis and rotating the work piece support on the second axis; and
a tool support for supporting the tool in such a manner that the tool is maintained in a predetermined position with respect to the first axis,
wherein the revolution-rotation driving device further includes a revolution-radius adjustment for adjusting a distance between the first axis and the second axis,
and wherein the revolution-rotation driving device maintains a direction of the revolution of the work piece support and a direction of the rotation of the work piece support in a same direction and allows a ratio of the number of revolution of the work piece support to the number of rotation of the work piece support to be maintained in a constant ratio of n (natural number):1.

2. The apparatus of claim 1, wherein the revolution-rotation driving device further includes a sun-shaft extending along the first axis and a planet-shaft to which the work piece support is fixed, the planet-shaft extending along the second axis.

3. The apparatus of claim 2, wherein the revolution-rotation driving device further includes a first driving motor rotating the sun-shaft on the first axis and a second driving motor for rotating the planet-shaft on the second axis.

4. The apparatus of claim 1, wherein the revolution-radius adjustment of the revolution-rotation driving device includes a revolution frame rotating on the first axis, a transfer screw mounted to the revolution frame and extending in a direction perpendicular to the first axis, and a transfer module to which the planet-shaft is attached, the transfer module movable in a radial direction of the first axis along the transfer screw.

5. The apparatus of claim 1, wherein the revolution-rotation driving device further includes a rotational plate rotating on the first axis, an internal gear being rotatable on the second axis and rotatably supported by the rotational plate, the internal gear connected to the work piece support, and an external gear cooperating with the internal gear, wherein the external gear is linked to a fixed shaft at its portion separated from a center of the external gear, a distance between the first axis and the center of the external gear is identical to a distance between the fixed shaft and the portion of the external gear, and a distance between the first axis and the fixed shaft is identical to a distance between the center of the external gear and the portion of the external gear.

6. The apparatus of claim 2, wherein the revolution-rotation driving device further includes a sun-gear existing on the first axis and being stationary, a rotational plate to which the planet-shaft is rotatably mounted, the rotational plate attached to the sun-shaft to be rotatable on the first axis, a planet-gear fixed to the planet-shaft, and a connection gear connecting the sun-gear to the planet-gear.

7. The apparatus of claim 6, wherein the connection gear includes a first intermediate gear cooperating with the sun-gear, a second intermediate gear cooperating with the planet-gear, and an intermediate shaft connecting the first intermediate gear to the second intermediate gear.

8. The apparatus of claim 7, wherein the revolution-radius adjustment is configured in such a manner that, when a position of the intermediate shaft is stationary with respect to the rotational plate, the planet-gear is engaged with the first intermediate gear and to be moved around the intermediate shaft.

9. The apparatus of claim 2, wherein the revolution-rotation driving device further includes a rotational plate to which the planet-shaft is rotatably mounted, the rotational plate being rotatable on the first axis, and a power-transmitting device transmitting a rotational force from the sun-shaft to the planet-shaft.

10. The apparatus of claim 9, wherein the power transmitting device is of a constant joint or a universal joint.

11. The apparatus of claim 10, wherein the universal joint is adapted to adjust relative angular position of both joints to each other.

12. The apparatus of claim 9, wherein the power transmitting device includes an input gear rotatable with the sun-shaft, an output gear rotatable with the planet-gear, an intermediate gear cooperating with the input gear and the output gear, a first link rotatably connecting a shaft of the intermediate gear and the planet-shaft, and a second link rotatably connecting the shaft of the intermediate gear and the sun-shaft.

13. The apparatus of claim 1, wherein the revolution-rotation driving device further includes a chain or a timing belt for revolving the work piece support around the first axis and a chain or a timing belt for rotating the work piece support on the second axis.

14. The apparatus of claim 1, wherein the revolution-rotation driving device further includes a controller for changing the ratio of the number of revolution of the work piece support to the number of rotation of the work piece support.

15. A method of making a product, comprising the steps of:
locating a work piece to be shaped or processed on a work piece support;
revolving the work piece support around a first axis, rotating the work piece support on a second axis at the same time, maintaining a direction of the revolution of the work piece support and a direction of the rotation of the work piece support in a same direction, and allowing a ratio of the number of revolution of the work piece support to the number of rotation of the work piece support to be maintained in a constant ratio of n (natural number):1; and
positioning a tool in a position separated from the first axis by a predetermined distance.

16. The method of claim 15, further comprising a step of adjusting a distance between the first axis and the second axis.

17. The method of claim 15, further comprising a step of adjusting a distance between the first axis and the tool.

18. A product made by a method of making a product, the method comprising the steps of:
locating a work piece to be shaped or processed on a work piece support;
revolving the work piece support around a first axis, rotating the work piece support on a second axis at the same time, maintaining a direction of the revolution of the work piece support and a direction of the rotation of the work piece support in a same direction, and allowing a ratio of the number of revolution of the work piece support to the number of rotation of the work piece support to be maintained in a constant ratio of n (natural number):1; and
positioning a tool in a position separated from the first axis by a predetermined distance.

19. The product of claim 18, wherein the product has a polygonal shape.
